(19) United States
(12) Patent Application Publication
(10) Pub. No.: US 2007/0145645 A1
(43) Pub. Date: Jun. 28, 2007

(54) Injection-molding method and apparatus

(76) Inventor: Young Jin Song, Paju-City (KR)

Correspondence Address: SCHMEISER OLSEN & WATTS, 18 E UNIVERSITY DRIVE, SUITE # 101, MESA, AZ, 85201, US

(21) Appl. No.: 11/351,146

(22) Filed: Feb. 8, 2006

(30) Foreign Application Priority Data
Dec. 23, 2005 (KR) 10-2005-0129076

(51) Int. Cl. B29C 45/00

(52) U.S. Cl. 264/328.1; 425/162; 425/190; 425/569

(57) ABSTRACT

Injection-molding method and apparatus. The mold device is composed of a plurality of unit mold devices each of which comprises cassette type molds configured to allow their cores defining a molding space between them to be changed. The unit mold devices are arranged at regular intervals to be opened and closed in a horizontal direction to thereby allow the molded product to freely fall. The unit mold devices sequentially and respectively conduct a mold clamping process, an injection process, a cooling process and an ejection process under the control of control means. Injection means is moved above the unit mold devices in accordance with a preset cycle and time and raised and lowered to be brought into contact with the cores of the unit mold device having conducted the mold clamping process to then inject melted resin and finally obtain a molded product.

### BACKGROUND OF THE INVENTION

1. Field of the invention

The present invention relates to an injection-molding method and apparatus, and more particularly to an injection-molding method which can mass-produce a keypad for a hand-held phone in a reduced space at a reduced cost, thereby improving productivity, decreasing the number of processes, saving a manufacturing cost, ensuring easy repair and maintenance and enhancing space utilization efficiency, and an injection-molding apparatus for effectively implementing the injection-molding method.

2. Description of the Prior Art

As is generally known in the art, when manufacturing a keypad for a hand-held phone, a polycarbonate-based material is injection-molded using molds to obtain a keypad preform having a desired shape. Then, the keypad preform undergoes cleaning, primary alignment, primary drying, spraying of paint having a desired color, secondary drying, embossing or engraving of characters or numbers through laser processing, washing, secondary alignment, UV-coating, blanking, and inspection, as a result of which an end product of keypad is obtained.

Injection-molding apparatuses for injection-molding a keypad, having various mechanical structures and shapes, have been disclosed in the art. Usually, the keypad is mass-produced by an injection-molding apparatus using two or three-staged molds.

A conventional injection-molding method implemented by the conventional injection-molding apparatuses includes a mold clamping process for closing molds, a nozzle touching process for connecting an injection unit with a resin inlet of the molds, an injection process for injecting melted resin into the molds at a predetermined pressure, a holding process for maintaining an injection pressure until the melted resin in the molds is set, a cooling and metering process for cooling the resin in the molds, introducing a predetermined amount of resin to be injected into the injection unit and melting the introduced resin, and a mold unclamping process for opening the molds to eject the molded product adhered to a core.

The conventional injection-molding method and apparatus encounter several problems as described below.

First, since two or three-staged molds are used, a great deal of mold fabrication costs and a wide mold storage space are required, and it takes a lot of time to change the molds. Also, an injection cycle time is lengthened to deteriorate productivity.

Second, because the amount of a sprue which is not recyclable approaches 80% of an original material amount, the sprue generation serves as a main cause of increasing a manufacturing cost. Further, in order to ensure easy ejection of the molded product, a release agent should be used every two or three injection-molding cycles.

Third, due to the fact that supplementary devices such as an ejection robot, a hot oiling machine, a cooler, and so forth are required, an equipment cost is increased. Moreover, as a wide installation area is required, space utilization efficiency is degraded.

Fourth, as the size of the entire injection-molding apparatus is significant, a proportional power level is needed, whereby power consumption is increased and a manufacturing cost further rises.

In addition, since a peripheral portion around the keypad must conform to the shape and standard of the keypad to be injection-molded, it is difficult to standardize and automate the post-processes which are to be implemented after injection-molding.

### SUMMARY OF THE INVENTION

Accordingly, an object of the present invention is to provide an injection-molding method which can positively solve the above-mentioned problems occurring in the prior art, and an injection-molding apparatus which can, effectively implement the injection-molding method.

In order to achieve the above object, according to one aspect of the present invention, there is provided an injection-molding method in which injection means injects resin metered to a predetermined amount and melted, into a mold device operated to be opened and closed, in a compressed state, and, after injected resin is cooled, a molded product is ejected, wherein the mold device is composed of a plurality of unit mold devices each of which comprises cassette type molds configured to allow their cores defining a molding space between them to be changed, the plurality of unit mold devices being arranged at regular intervals to be opened and closed in a horizontal direction to thereby allow the molded product to freely fall such that the plurality of unit mold devices sequentially and respectively conduct a mold clamping process, an injection process, a cooling process and an ejection process under the control of control means, and the injection means is moved through a predetermined distance above the unit mold devices in accordance with a cycle and a time inputted to the control means and raised and lowered to be brought into contact with the cores, of the unit mold device having conducted the mold clamping process to then inject melted resin and finally obtain the molded product.

According to another aspect of the present invention, there is provided an injection-molding apparatus comprising a frame; a plurality of unit mold devices installed on the frame to be opened and closed in a horizontal direction and each having therein cores to be changed with new ones depending upon a molded product; injection means installed to be moved through a predetermined distance above the plurality of unit mold devices and to be raised and lowered by a feeding mechanism, and configured to be brought into contact with the cores of each unit mold device to thereby inject melted resin into each unit mold device; and control means for controlling an operation sequence, an operation cycle and an operation time of the unit mold device, the feeding mechanism and the injection means.

### BRIEF DESCRIPTION OF THE DRAWINGS

The above and other objects, features and advantages of the present invention will be more apparent from the following detailed description when taken in conjunction with the accompanying drawings, in which:

FIG. 1 is a side view of an injection-molding apparatus in accordance with an embodiment of the present invention;

FIG. 2 is a front view of the injection-molding apparatus in accordance with the embodiment of the present invention;

FIG. 3 is a plan view of the injection-molding apparatus in accordance with the embodiment of the present invention;

FIG. 4 is a plan view illustrating a unit mold device constituting the injection-molding apparatus in accordance with the embodiment of the present invention; and

FIG. 5 is a front view illustrating the unit mold device constituting the injection-molding apparatus in accordance with the embodiment of the present invention.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

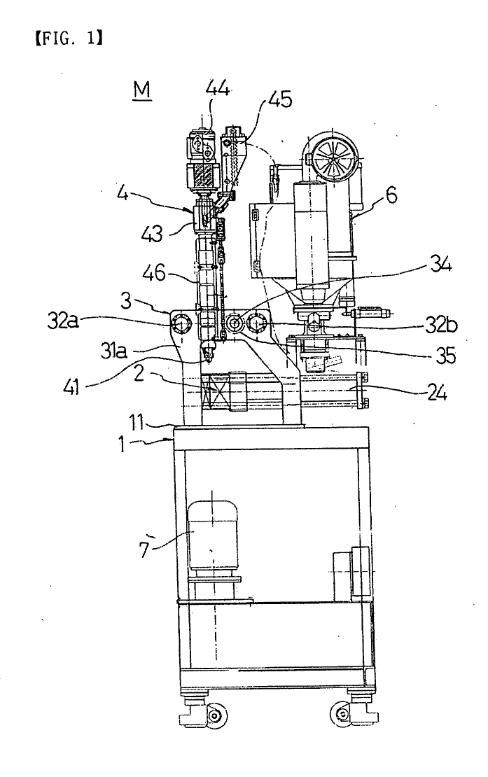

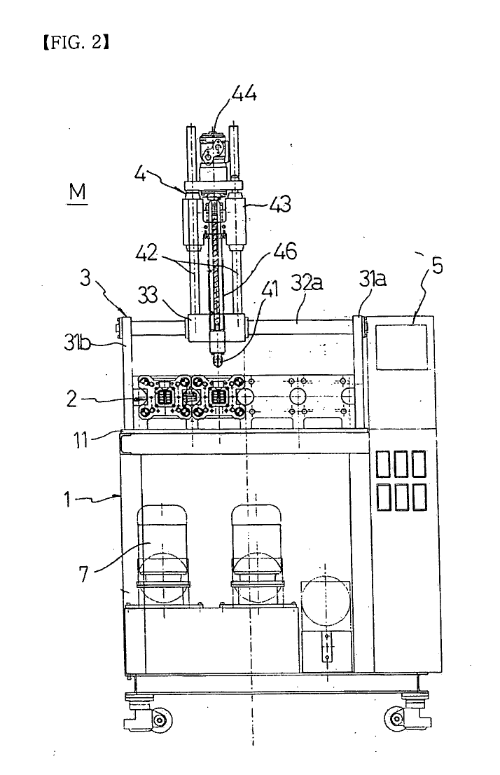

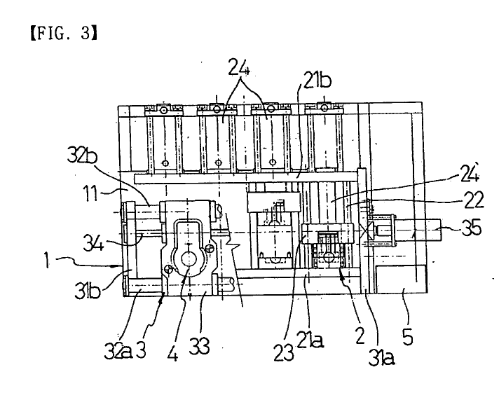

FIG. 1 is a side view of an injection-molding apparatus ‘M’ in accordance with an embodiment of the present invention, and FIGS. 2 and 3 are respectively a front view and a plan view of the injection-molding apparatus.

The injection-molding apparatus ‘M’ in accordance with the embodiment of the present invention includes a frame 1, a plurality of unit mold devices 2 arranged on the frame 1, injection means 4 installed to be moved through a predetermined distance above the plurality of unit mold devices 2 and to be raised and lowered by a feeding mechanism 3 such that the injection means 4 is sequentially brought into contact with the unit mold devices 2 to inject melted resin into each unit mold device 2, and control means 5 for controlling an operation sequence, an operation cycle and an operation time of the unit mold devices 2, the feeding mechanism 3 and the injection means 4.

The frame 1 comprises a quadrangular framework which has a predetermined height and width. Preferably, in the frame 1, a chute (not shown) for guiding the drop of and collecting the molded products ejected from the unit mold devices 2 as will be described later is disposed below an installation plate 11.

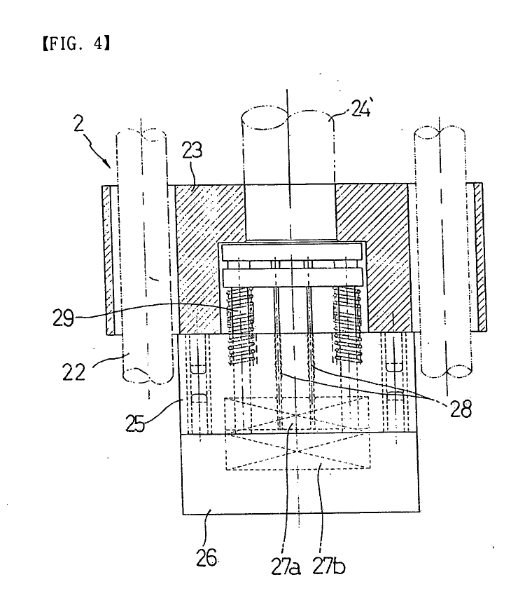

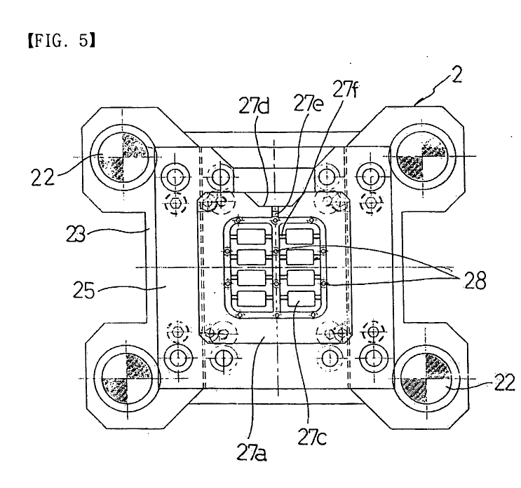

The unit mold devices 2 are installed on fixed blocks 21a and 21b which are oppositely installed on the front and rear parts of the frame 1 such that they can be opened and closed in the horizontal direction by respective cylinders 24. FIG. 4 schematically illustrates a plan view of the unit mold device 2, and FIG. 5 is a front view illustrating the cores which constitute the unit mold device 2.

The unit mold device 2 comprises a spacer block 23 which is slidably installed on guide bars 22 secured between the fixed blocks 21a and 21b, a cylinder 24 which is installed behind the fixed block 21b and has a cylinder rod 24′ for moving the spacer block 23 forwards and rearwards, a movable die 25 which is secured to the front portion of the spacer block 23, a fixed die 26 which is secured to the fixed block 21a to face the movable die 25, movable and fixed cores 27a and 27b which are respectively secured to the movable die 25 and the fixed die 26 to cooperatively define a molding space 27c, a plurality of ejection pins 28 which are installed in the spacer block 23 to be selectively extended out of and retracted into the movable core 27a to thereby eject the molded product, and return pins 29 which are provided to return the ejection pins 28 to their original positions.

A nozzle contact part 27d with which a nozzle 41 of the injection means 4 is brought into contact as will be described later is formed on the upper ends of the movable and fixed cores 27a and 27b, and a gate 27e which communicates with the nozzle contact part 27d communicates with a runner 27f to supply melted resin into the molding space 27c.

The feeding mechanism 3 for moving the injection means 4 leftwards and rightwards above the unit mold devices 2 through the predetermined distance comprises a pair of support blocks 31a and 31b which are oppositely positioned on the frame 1, a pair of slide bars 32a and 32b which are secured to the front and rear ends of the support blocks 31a and 31b, a holder 33 which is slidably installed on the slide bars 32a and 32b, a feed screw shaft 34 which is installed between the support blocks 31a and 31b to pass through the holder 33, and a motor 35 for rotating the feed screw shaft 34 in both forward and backward directions.

The injection means 4 comprises guide bars 42 which are vertically secured to the holder 33, a vertically moving cylinder 53 which is slidably installed on the guide bars 42 to be raised and lowered on the guide bars 42, a motor 44 which is securely installed on the vertically moving cylinder 53 to meter and compress resin material, an introduction section 45 which introduces therein a predetermined amount of resin from a hopper 6 upon driving of the motor 44, a melting section 46 which melts the introduced resin material, and the nozzle 41 which injects the melted resin into the unit mold device 2 by virtue of the compression force from the motor 44.

The control means 5 is provided on a side of the frame 1 and is installed to be electrically connected with the unit mold devices 2, the feeding mechanism 3 and the injection means 4 so as to control an operation sequence, an operation cycle and an operation time of the unit mold devices 2, the feeding mechanism 3 and the injection means 4.

The unexplained reference numeral 7 designates a hydraulic unit for constituting a hydraulic circuit.

In the injection-molding apparatus M according to the present invention, constructed as mentioned above, in a state in which a large amount of resin material is received and the melting section 46 of the injection means 4 is sufficiently heated, the injection is started. It is the same as the conventional art that an injection procedure of the present invention is implemented according to an injection cycle in which a mold clamping process, an injection process, a cooling process and an ejection process are repeated.

However, in the present invention, the plurality of unit mold devices 2 (four unit mold devices 2 in the drawings) are aligned in a line, and the injection is implemented while the injection means 4 is sequentially moved through the predetermined distance by the feeding mechanism 3.

Concretely speaking, when the first unit mold device 2 conducts the injection process, the second unit mold device 2 conducts the mold clamping process, the third unit mold device 2 conducts the ejection process, and the fourth unit mold device 2 conducts the cooling process.

In the injection process, at the same time the vertically moving cylinder 43 of the injection means 4 which is positioned above the first unit mold device 2 is lowered and the nozzle 41 comes into close contact with the nozzle contact part 27d of the movable and fixed cores 27a and 27b, the melted resin is injected into the first unit mold device 2. Further, at the same time the injection and holding procedures are completed, the vertically moving cylinder 43 is raised to separate the structure including the motor 44, the introduction section 45, the melting section 46 and the nozzle 41, from the nozzle contact part 27d of the movable and fixed cores 27a and 27b.

In succession, the motor 35 of the feeding mechanism 3 drives the feed screw shaft 34 to move and position the injection means 4 above the second unit mold device 2. Then, the first unit mold device 2 conducts the cooling process, the second unit mold device 2 conducts the injection process, the third unit mold device 2 conducts the mold clamping process, and the fourth unit mold device 2 conducts the ejection process.

In this way, the unit mold devices 2 sequentially conduct the injection process, the mold clamping process, the ejection process and the cooling process in conformity with the arrangement sequence of the unit mold devices 2. After the injection process and the mold clamping process are completed, the injection means 4 is moved above the next unit mold device 2 to implement the injection. As a consequence, since a process standby time is shortened, the time required for completing one process cycle is decreased, by which productivity can be improved.

Next, the injection-molding procedure in the unit mold devices 2 for obtaining the molded product will be described.

First, in the mold clamping process, as the cylinder rod 24′ of the cylinder 24 is extended and the spacer block 23 and the movable die 25 are moved forward to be brought into contact with the fixed die 26, the molding space 27c is defined between the movable and fixed cores 27a and 27b which are respectively provided to the movable and fixed dies 25 and 26 to face each other.

In this mold-clamped state, the nozzle 41 of the injection means 4 is lowered to be brought into close contact with the nozzle contact part 27d and the melted resin is injected, the injected melted resin is poured into the molding space 27c through the gate 27e and the runner 27f, and thereafter, with the holding and cooling procedures completed, the ejection process is conducted.

In the ejection process, the cylinder rod 24′ of the cylinder 24 is retracted to separate the movable die 25 from the fixed die 26. Then, ejection rods move the ejection pins 28 forward to eject the cooled product from the molding space 27c. At the same time the ejected product falls downwards toward the lower part of the frame 1, the ejection pins 28 are returned to their original positions by the return pins 29.

In the injection-molding apparatus M according to the present invention, by using the so-called cassette type molds in which the movable and fixed cores 27a and 27b are respectively assembled to the movable and fixed dies 25 and 26, a mold manufacturing cost can be saved, and the change and storage of the molds can be easily implemented. Further, since the peripheral portion around the keypad can be standardized, the post-processes which are to be implemented after injection-molding can be automated.

Further, due to the fact that only one molding space 27c is defined by the movable and fixed cores 27a and 27b, it is possible to implement injection using a reduced level of power, and it is possible to overcome the problem caused due to the differences in qualities of molded products, which is otherwise provoked in the conventional art when multiple molding spaces are defined in one mold, whereby a yield can be increased. In particular, because the generation of a sprue is significantly reduced, the manufacturing cost can be further decreased.

As is apparent from the above descriptions, the injection-molding method and apparatus according to the present invention provide advantages in that, since it is possible to mass-produce a keypad for a hand-held phone in a reduced space at a reduced cost, productivity can be improved, a manufacturing cost can be saved, easy repair and maintenance can be ensured, space utilization efficiency can be enhanced, and a yield can be increased. Also, because a peripheral portion of a molded product can be standardized, the post-processes which are to be implemented after injection-molding can be automated.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An injection-molding method in which injection means injects resin metered to a predetermined amount and melted, into a mold device operated to be opened and closed, in a compressed state, and, after injected resin is cooled, a molded product is ejected, wherein the mold device is composed of a plurality of unit mold devices each of which comprises cassette type molds configured to allow their cores defining a molding space between them to be changed, the plurality of unit mold devices being arranged at regular intervals to be opened and closed in a horizontal direction to thereby allow the molded product to freely fall such that the plurality of unit mold devices sequentially and respectively conduct a mold clamping process, an injection process, a cooling process and an ejection process under the control of control means, and the injection means is moved through a predetermined distance above the unit mold devices in accordance with a cycle and a time inputted to the control means and raised and lowered to be brought into contact with the cores of the unit mold device having conducted the mold clamping process to then inject melted resin and finally obtain the molded product.

2. An injection-molding apparatus comprising:
a frame;
a plurality of unit mold devices arranged on the frame;
injection means installed to be moved through a predetermined distance above the plurality of unit mold devices and to be raised and lowered by a feeding mechanism such that the injection means is sequentially brought into contact with the unit mold devices to inject melted resin into each unit mold device; and
control means for controlling an operation sequence, an operation cycle and an operation time of the unit mold device, the feeding mechanism and the injection means.

3. The injection-molding apparatus as claimed in claim 2, wherein movable and fixed cores are detachably secured to movable and fixed dies which constitute the unit mold device such that the movable and fixed cores cooperatively define a molding space between them, a nozzle contact part with which a nozzle of the injection means is brought into contact is formed on upper ends of the movable and fixed cores, and a gate communicating with the nozzle contact part communicates with a runner to supply melted resin into the molding space.

4. The injection-molding apparatus as claimed in claim 2, wherein the feeding mechanism comprises a pair of support blocks oppositely positioned on the frame, a pair of slide bars secured to front and rear ends of the support blocks, a holder slidably installed on the slide bars to move the injection means, a feed screw shaft installed between the support blocks to pass through the holder, and a motor for rotating the feed screw shaft in forward and backward directions.
